(19) United States
(12) Patent Application Publication
(10) Pub. No.: US 2021/0331415 A1
(43) Pub. Date: Oct. 28, 2021

(54) ENERGY ABSORBING AGENT ADJUSTMENTS

(71) Applicant: HEWLETT-PACKARD DEVELOPMENT COMPANY, L.P., Spring, TX (US)

(72) Inventors: Arthur H Barnes, Vancouver, WA (US); Vanessa Verzwyvelt, Vancouver, WA (US); Matthew A Shepherd, Vancouver, WA (US)

(21) Appl. No.: 16/608,255

(22) PCT Filed: Jun. 15, 2018
(86) PCT No.: PCT/US2018/037810

§ 371 Date: Oct. 25, 2019

(51) Int. Cl. B29C 64/393; B29C 64/165; B29C 64/209; B29C 64/336; B33Y 50/02

(52) U.S. Cl. CPC B29C 64/393; B29C 64/165; B33Y 10/00; B29C 64/336; B33Y 50/02; B29C 64/209

(57) ABSTRACT

A system determines a difference in energy absorptions by a plurality of different energy absorbing agents used to form an object by an additive manufacturing machine. The system adjusts, based on the determined difference, an amount of an energy absorbing agent of the plurality of different energy absorbing agents dispensed for a build operation of the additive manufacturing machine.

### BACKGROUND

Additive manufacturing machines produce three-dimensional (3D) objects by building up layers of material. A type of an additive manufacturing machine is referred to as a 3D printing system. Additive manufacturing machines are able to receive as input a computer aided design (CAD) model or other digital representation of a physical 3D object to be formed, and build, based on the CAD model, the physical 3D object. The model may be processed into layers by the additive manufacturing machine, and each layer defines a corresponding part (or parts) of the 3D object.

### BRIEF DESCRIPTION OF THE DRAWINGS

Some implementations of the present disclosure are described with respect to the following figures.

FIG. 1 illustrates an example of using test patches formed using different energy absorbing agents in a control region to adjust dispensing of an energy absorbing agent, in accordance with some examples.

FIG. 2 is a flow diagram of an energy absorbing agent adjusting process according to some examples.

FIG. 3 is a block diagram of an additive manufacturing machine according to some examples.

FIG. 4 is a block diagram of a storage medium storing machine-readable instructions according to some examples.

FIG. 5 is a block diagram of an additive manufacturing machine according to further examples.

FIG. 6 is a flow diagram of an energy absorbing agent adjusting process according to further examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

An additive manufacturing machine such as a three-dimensional (3D) printing system can build 3D objects by forming successive layers of build material and processing each layer of build material on a build platform. In some examples, a build material can include a powdered build material that is composed of particles in the form of fine powder or granules. The powdered build material can include metal particles, plastic particles, polymer particles, ceramic particles, or particles of other powder-like materials. In some examples, a build material powder may be formed from, or may include, short fibers that may, for example, have been cut into short lengths from long strands or threads of material.

As part of the processing of each layer of build material, agents can be dispensed (such as through a printhead or other liquid delivery mechanism) to the layer of build material. Examples of agents include a fusing agent (which is a form of an energy absorbing agent) that absorbs the heat energy emitted from an energy source used in the additive manufacturing process. For example, after a layer of build material is deposited onto a build platform (or onto a previously formed layer of build material) in the additive manufacturing machine, a fusing agent with a target pattern can be deposited on the layer of build material. The target pattern can be based on an object model (or more generally, a digital representation) of the physical 3D object that is to be built by the additive manufacturing machine.

According to an example, a fusing agent may be an ink-type formulation including carbon black, such as, for example, the fusing agent formulation commercially referred to as the V1Q60Q “HP fusing agent” available from HP Inc. In an example, a fusing agent may additionally include an infrared light absorber, a near infrared light absorber, a visible light absorber, or an ultraviolet (UV) light absorber. Fusing agents can also refer to a chemical binding agent, such as used in a metal 3D printing system.

Following the application of the fusing agent, an energy source (e.g., including a heating lamp or multiple heating lamps that emit(s) energy) is activated to sinter, melt, fuse, bind, or otherwise coalesce the powder of the layer of build material underneath the fusing agent. The patterned build material layer (i.e., portions of the layer on which the fusing agent was deposited) can solidify and form a part, or a cross-section, of the physical 3D object.

Next, a new layer of powder is deposited on top of the previously formed layer, and the process is re-iterated in the next additive manufacturing cycle.

In some cases, different fusing agents can be used to form parts in a build material layer during an additive manufacturing process. The different fusing agents can have different energy absorbing characteristics. In some examples, a first fusing agent can include a first type of pigment, and a second fusing agent can include a second type of pigment different from the first type of pigment. The first type of pigment can cause the first fusing agent to absorb more energy (e.g., heat) from the energy source than the second type of pigment.

In more general examples, the first fusing agent can include a first energy absorbing component, while the second fusing agent can include a second energy absorbing component. For example, the first fusing agent can include pigment-based black ink, while the second fusing agent can include cesium as an energy absorber. In such an example, the second fusing agent absorbs less energy than the second fusing agent. More generally, different fusing agents can use different types of energy absorbing components. For example, the first fusing agent containing a first type of energy absorbing agent can absorb more energy in a particular energy bandwidth (such as in a particular electromagnetic bandwidth) of energy emissions of an energy source than the second fusing agent containing a second type of energy absorbing component.

In the ensuing discussion, a fusing agent that is more energy absorptive is referred to as a “more absorptive fusing agent,” and a fusing agent that is less energy absorptive is referred to as a “less absorptive fusing agent.”

In further examples, other types of additive manufacturing agents can be added to a layer of build material. For example, a detailing agent may be provided to achieve a target surface quality and accuracy in forming a part. The detailing agent may also, in some examples, be used to provide cooling or thermal control in regions of the build material. In some examples, a detailing agent can include water. In more specific examples, a detailing agent may be a formulation commercially referred to as the V1Q61A “HP detailing agent” available from HP Inc.

Further additive manufacturing agents can include different colorant agents (such as dye-based colorant agents) to form regions of respective colors in corresponding parts of the 3D object built by the additive manufacturing machine. The colorant agents can include a cyan agent, a magenta agent, a yellow agent, and a cosmetic black agent. The cyan, magenta, and yellow agents have minimal IR absorption, and the cosmetic black agent has a small but non-negligible IR absorption. Examples of colorant agents include visible light enhancers that include dye-based colored ink and pigment-based colored ink, such as inks commercially referred to as CE039A and CE042A available from HP Inc. Other colorant agents can be used in other examples.

In an additive manufacturing process that forms a part that has a color, the foregoing different additive manufacturing agents can be used to provide strength and color to the part. The additive manufacturing agents are dispensed in different quantities and patterns as parts are constructed in respective layers of a build material.

To precisely control the surface temperature of a part as the part is being fabricated, it is desired to correctly balance the energy absorption by the different additive manufacturing agents used in the construction of the part to achieve acceptable material properties of the part. Examples of material properties include tensile strength, modulus of elasticity, impact strength, elongation at break, and so forth. Unbalanced and uncontrolled energy absorption caused by the variations in absorption characteristics of the different additive manufacturing agents can lead to unacceptable material properties, such as due to a layer of build material not reaching a target temperature (or not staying at the target temperature long enough) in response to a given amount of energy from an energy source, or due to a layer of build material exceeding a target temperature (or staying at the target temperature for too long a time) in response to a given amount of energy from the energy source.

Variations in energy absorption by an energy absorbing agent can be due to various factors. For example, a low tint fusing agent can include an unstable mixture of an energy absorbing pigment (e.g., cesium) and other materials. The low tint fusing agent can suffer variation in energy absorption over time due to the pigment in the fusing agent falling out of a solution of the fusing agent over time. A pigment settling out of the solution refers to particles of the pigment separating (such as by settling due to gravity) from other materials in the mixture of the fusing agent, which causes the remaining mixture to have a different energy absorption characteristic.

As a further example, a liquid dispenser (e.g., including a printhead that has nozzles) for a fusing agent (e.g., a low tint fusing agent) can accumulate pigment particles of the fusing agent as the fusing agent is dispensed by the agent dispenser. For example, the agent dispenser can include activation elements (e.g., firing resistors) on which particles of the fusing agent can accumulate as contaminants. The accumulation of the contaminants on the agent dispenser reduces the effectiveness of the agent dispenser, which can lead to a change in an intended/target amount of the fusing agent that is dispensed. As a result, the amount of the fusing agent dispensed onto a layer of build material can deviate from a target amount of the fusing agent. A reduction in the amount of the fusing agent dispensed by the agent dispenser can lead to a reduced energy absorption by the fusing agent.

Although the foregoing provides examples of a low tint fusing agent exhibiting variability in energy absorption characteristics due to various factors, in other examples, other energy absorbing agents (including different colored energy absorbing agents or other types of energy absorbing agents) may also exhibit variability in energy absorption characteristics.

In accordance with some implementations of the present disclosure, to achieve more balanced and controlled absorption of energy from an energy source in a layer of build material in response to an amount of energy from an energy source, a controller performs a calibration operation in an additive manufacturing machine. The calibration operation determines a difference in energy absorptions by a plurality of different energy absorbing agents (e.g., different fusing agents and/or other types of additive manufacturing agents including the detailing agent and colorant agents) used to form a part of an object in a layer of build material by an additive manufacturing machine. The calibration operation calculates an adjustment value based on the determined difference in energy absorptions by the different energy absorbing agents. Subsequently, during a build operation for forming a part of a 3D object by the additive manufacturing machine, the controller adjusts, based on the adjustment value, an amount of an energy absorbing agent (or amounts of multiple energy absorbing agents) dispensed in the build operation.

The adjusting is to balance energy absorptions by the plurality of different energy absorbing agents during the build operation that achieves a target energy absorption level in a layer of build material responsive to energy from an energy source, despite a variation in an energy absorption characteristic of at least one of the plurality of different energy absorbing agents.

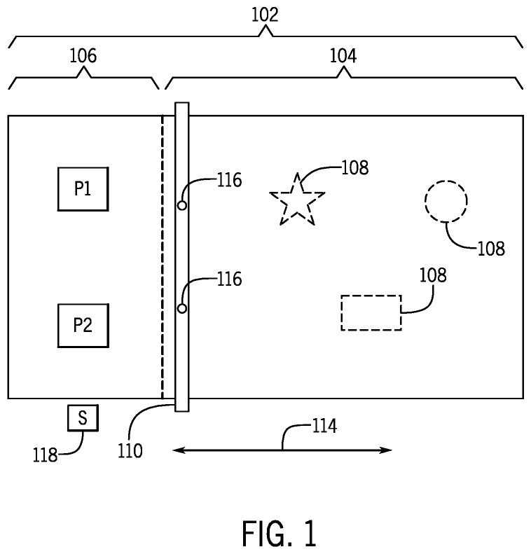

FIG. 1 is a top view of a build material layer 102 (which can be formed on a build platform or on a partially built 3D object). The build material layer 102 includes a build region 104 and a control region 106. The control region 106 in the build material layer 102 is separate from the build region 104. The build region 104 of the layer of build material is a region where a portion (parts 108) of a target 3D object is to be formed. The parts 108 are formed in the build region 104 based on application of various additive manufacturing agents, including fusing agents, detailing agents, and colorant agents. The application of a pattern and amounts of the additive manufacturing agents is based on an object model (or more generally, digital representation) of a 3D object to be built by an additive manufacturing machine.

The parts 108 are shown in dashed profile in FIG. 1 because they are not actually formed in the build material layer 104 during a calibration operation used for calibrating for differences in energy absorptions by different energy absorbing agents according to some implementations of the present disclosure. Rather, the parts 108 are formed later (in subsequent build material layers) after the calibration operation has been performed.

The control region 106 is away from the build region 104. In some examples, the control region 106 is part of a boundary region around the edge of a build platform. The control region 106 is provided due to thermal losses at the sides of the build platform. In other examples, the control region 106 can be provided in any other region of the build platform.

An energy source 110 (which can also be referred to as a “fusing module”) is provided above the build material layer 102. The energy source 110 includes a heater 116 (or multiple heaters) that when activated apply heat directed to the build material layer 102. For example, a heater can include an IR heat lamp.

In some examples, the energy source 110 is movable across the build material layer 102 along an axis 114. In other examples, the energy source 110 can be movable across other axes. More generally, the energy source 110 is movable relative to the build material layer 102, where such relative movement can be accomplished by either moving the energy source 110 or moving a build platform on which the build material layer 102 is provided, or both.

To perform a calibration operation according to some implementations of the present disclosure, test patches P1 and P2 are formed in the control region 106 for use in determining differences in energy absorptions by respective different energy absorbing agents.

In some examples, the test patches P1 and P2 are formed by dispensing respective different fusing agents onto the corresponding areas of P1 and P2 in the control region 106. For example, the test patch P1 is formed by dispensing a first type of fusing agent (e.g., a more absorptive fusing agent), and the test patch P2 is formed by dispensing a second type of fusing agent (e.g., a less absorptive fusing agent).

More generally, the different test patches are formed using respective different types of energy absorbing agents, including fusing agents, detailing agents, and colorant agents. Although just two test patches are shown in FIG. 1, it is noted that in other examples, more than two test patches printed using respective different energy absorbing agents can be formed in the control region 106.

In some examples, the test patches P1 and P2 formed using different types of energy absorbing agents can be formed on the same layer of build material. In other examples, the test patches P1 and P2 formed using different types of fusing agents can be formed on respective different layers of build material (i.e., P1 is formed in a first layer (or set of layers) of build material, and P2 is formed in a different second layer of build material). For purposes of the discussion of some examples, it is assumed that P1 and P2 are formed in the same layer of build material. Techniques or mechanisms according to the present disclosure can be applied to test patches P1 and P2 formed in different layers of build material in other examples.

The test patches P1 and P2 cause formation of respective control parts in the build material 102. A control part is also referred as a “sacrificial part”. The control parts corresponding to P1 and P2 are generated by an additive manufacturing machine for a calibration operation, and are not based on an object model used for building a 3D object by the additive manufacturing machine. The control parts are intended to be discarded once the additive manufacturing is complete.

As part of a calibration operation, the energy source 110 is activated to apply energy towards the control region 106. After or during the application of the energy by the energy source 110, a thermal characteristic (e.g., temperature) of the top surface of each of the test patches P1 and P2 can be measured, for example, using a thermal sensor 118 (e.g., a thermal camera or other thermal imaging device). Based on the measured thermal characteristics of the test patches P1 and P2, a difference in energy absorptions by the respective different energy absorbing agents used to form the test patches P1 and P2 can be determined. The determined energy difference is then used to compute an adjustment value that can be used for adjusting an amount of energy absorbing agent dispensed during a build operation for building parts 108 of a 3D object by the additive manufacturing machine.

In examples where the patches P1 and P2 are formed in the same build material layer 102, the thermal characteristics of the patches P1 and P2 in the same build material layer can be measured. In alternative examples where the patches P1 and P2 are formed in different layers, the thermal characteristic of the patch P1 formed in a first build material layer can be measured, and subsequently, the thermal characteristic of the patch P2 in a second build material layer can be measured.

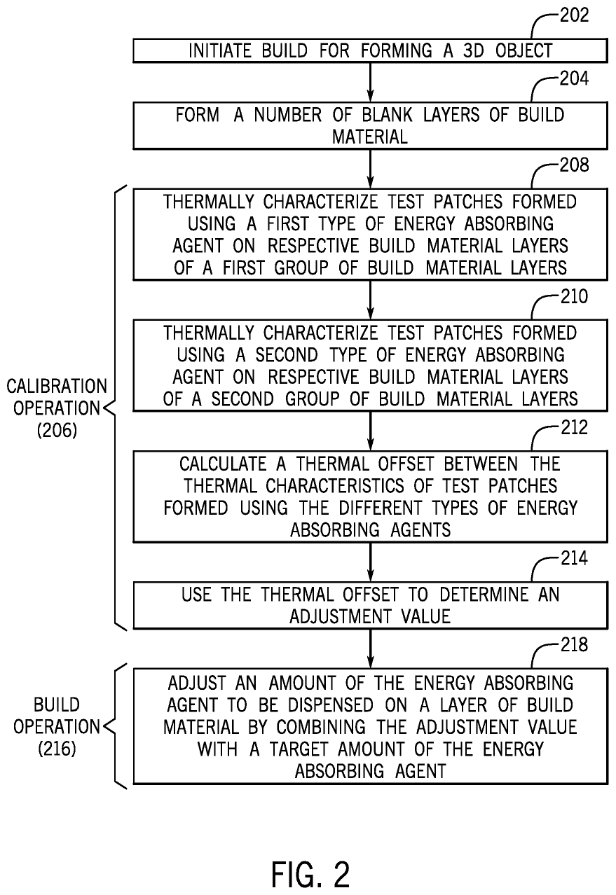

FIG. 2 is a flow diagram of a process according to some examples. A build for forming a 3D object is initiated (at 202) in the additive manufacturing machine. Initiating the build of the 3D object can be in response to a user request (e.g., a user loading an object model and activating a control element to start the 3D build), or in response to a request from another entity, such as a machine or program.

Although a specific order of tasks is shown in FIG. 2, it is noted that in other examples, the tasks can be performed in a different order, some of the tasks may be omitted, and/or other tasks may be added.

The additive manufacturing machine forms (at 204) a number of blank layers of build material to place the additive manufacturing machine in a condition of thermal stability. A blank layer of build material is a layer of build material onto which additive manufacturing agents are not dispensed.

Once the additive manufacturing machine has reached thermal stability, the additive manufacturing machine can start a calibration operation 206 to calibrate for differences in energy absorptions of multiple different energy absorbing agents.

The calibration operation 206 thermally characterizes (at 208) test patches formed using a first type of energy absorbing agent on respective build material layers of a first group of build material layers (which includes M layers, where M≥1). In task 208, after each test patch is formed using the first type of fusing agent on each respective build material layer of the first group of build material layers, a thermal characteristic (e.g., temperature) of the test patch is measured by a thermal sensor (e.g., 118 in FIG. 1).

The calibration operation 206 also thermally characterizes (at 210) test patches formed using a second type of energy absorbing agent on respective build material layers of a second group of build material layers (which includes N layers, where N≥1). In task 210, after each test patch is formed using the second type of fusing agent on each respective build material layer of the second group of build material layers, a thermal characteristic (e.g., temperature) of the test patch is measured by the thermal sensor.

Although reference is made to forming one test patch in each build material layer in tasks 206 and 208, it is noted that in other examples, multiple test patches can be formed in each build material layer in tasks 206 and 208.

Based on the measured thermal characteristics of the test patches formed using the different types of fusing agents in respective build material layers, the calibration operation 206 calculates (at 212) a thermal offset (e.g., a temperature offset) between the thermal characteristics of test patches formed using the different types of energy absorbing agents.

In some examples, an average (or other mathematical aggregate such as a weighted average, a mean, a maximum, a minimum, a sum, etc.) of the measured thermal characteristics of the test patches formed using the first type of energy absorbing agent in the first group of build material layers (or a subset of the first group of build material layers) can be computed to derive a first average (or other aggregate) thermal characteristic (e.g., a first average temperature). Similarly, an average (or other mathematical aggregate such as a weighted average, a mean, a maximum, a minimum, a sum, etc.) of the measured thermal characteristics of the test patches formed using the second type of energy absorbing agent in the second group of layers of build material (or a subset of the first group of build material layers) can be computed to derive a second average (or other aggregate) thermal characteristic (e.g., a second average temperature).

The thermal offset calculated at (212) can be based on a difference between the first average (or other mathematical aggregate) and the second average (or other mathematical aggregate). For example, the thermal offset can include a temperature offset calculated as a difference between the first average temperature and the second average temperature.

In alternative examples, instead of forming test patches using different types of energy absorbing agents in respective different groups of build material layers (as performed in tasks 208 and 210), multiple test patches using respective different types of energy absorbing agents can be formed in each build material layer (of a group of R build material layers, R≥1). In such alternative examples, the thermal characteristics (e.g., temperatures) of the corresponding test matches in each build material layer can be measured with a thermal sensor, and a thermal offset can be calculated based on the measured thermal characteristics of the corresponding test matches in each build material layer. Multiple thermal offsets calculated for the corresponding R build material layers (or a subset of the R build material layers) can be averaged (or subjected to another mathematical aggregate) to compute an average (or other aggregate) thermal offset.

The calibration operation 206 then uses (at 214) the thermal offset calculated (at 212) to determine an adjustment value to be used for controlling an amount of energy absorbing agent to be dispensed during a build operation of the additive manufacturing machine.

The controlling of the amount of energy absorbing agent can include adjusting a volume of energy absorbing agent per unit area, such as by adjusting a number of drops emitted by an agent dispenser per unit area. Based on an object model, a controller can prescribe a target proportion of each agent to be dispensed to achieve a target characteristic (e.g., color or other characteristic) of a part to be formed in a build material layer. This target proportion corresponds to a target volume of each agent to be dispensed per unit area. The adjustment value computed can adjust the target volume per unit area (e.g., adjusting the number of drops per unit volume dispensed by nozzles of the agent dispenser) for a corresponding energy absorbing agent, to account for the thermal offset between different energy absorbing agents.

In some examples, the calculated thermal offset (e.g., a temperature offset) can be used as a value to access an entry of multiple entries of lookup information, which in some examples can be implemented as a lookup table as set forth in Table 1 below.

TABLE 1

| Temperature Offset | Agent Drop Volume Adjustment |
|---|---|
| −7.19 | 0.80 |
| −7.02 | 0.82 |
| −6.85 | 0.85 |
| −6.69 | 0.88 |
| −6.54 | 0.90 |
| −6.39 | 0.92 |
| −6.25 | 0.95 |
| −6.12 | 0.97 |
| −6.00 | 1.00 |
| −5.88 | 1.02 |
| −5.78 | 1.05 |
| −5.68 | 1.07 |
| −5.58 | 1.10 |
| −5.50 | 1.13 |
| −5.42 | 1.15 |
| −5.35 | 1.17 |
| −5.29 | 1.20 |
| −5.23 | 1.22 |

The lookup table includes multiple entries, where each entry of the lookup table correlates a respective temperature offset to an agent drop volume adjustment value, which is a value that is used to adjust a volume of an energy absorbing agent dispensed by an agent dispenser of the additive manufacturing machine. Thus, for example, in the first entry of the lookup table above, a temperature offset of −7.19 is correlated to a value of 0.80 for the agent drop volume adjustment value. In some examples, the agent drop volume adjustment value is multiplied with a target agent drop volume of the energy absorbing agent to be dispensed by the agent dispenser. Based on the part(s) to be formed in a layer of build material, the controller of the additive manufacturing machine can set a target agent drop volume of a specific energy absorbing agent (such as the low tint fusing agent or other energy absorbing agent) to be dispensed by an agent dispenser. However, based on the temperature offset, the volume of the energy absorbing agent that is dispensed is changed by combining (e.g., multiplying) the agent drop volume adjustment value with the target agent drop volume.

During a build operation 216, the controller of the additive manufacturing machine adjusts (at 218) an amount of the energy absorbing agent to be dispensed on a layer of build material by combining the adjustment value (determined at 214) with a target amount of the energy absorbing agent. In the build operation 216, the controller first determines, based on an object model, locations at which energy absorbing agents are to be deposited and the types of energy absorbing agents to be deposited. The adjustment value can be used to adjust the amount of a specific type of energy absorbing agent dispensed. If multiple adjustment values are determined, then the amounts of multiple types of energy absorbing agents can be dispensed

Although reference is made to adjusting an amount of an energy absorbing agent in the singular sense, it is noted that this also covers an adjustment of amounts of multiple different energy absorbing agents based on the adjustment value.

In other examples, instead of accessing lookup information (such as the lookup table above) to determine an adjustment value, the controller can apply an algorithm, such as a formula, a machine learning model, and so forth, that produces an adjustment value based on a thermal offset calculated during the calibration operation.

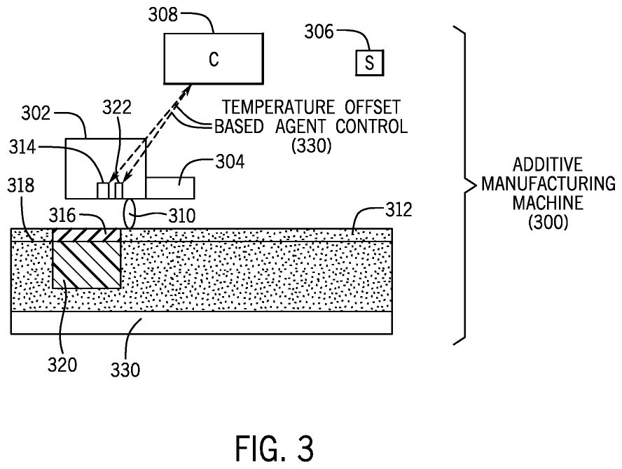

FIG. 3 is a schematic side view of an example additive manufacturing machine 300 according to some examples. The additive manufacturing machine 300 includes a dispensing assembly 302, an energy source 304, a thermal sensor 306, and a controller 308.

The controller 308 can be implemented as a hardware processing circuit, which can include any or some combination of the following: a microprocessor, a core of a multi-core microprocessor, a microcontroller, a programmable integrated circuit device, a programmable gate array, or another hardware processing circuit. Alternatively, the “controller” can be implemented as a combination of a hardware processing circuit and machine-readable instructions (software and/or firmware) executable on the hardware processing circuit.

The thermal sensor 306 measures a thermal characteristic (e.g., a temperature) of test patches in the control regions of build material layers. Although reference is made to one thermal sensor 306, it is noted that there may be multiple thermal sensors 306 to measure the thermal characteristics of test patches in other examples. The thermal sensor 306 outputs a measured thermal characteristic of each test patch to the controller 308.

The dispensing assembly 302 can include a build material spreader 310 to dispense and spread a build material layer 312, and agent dispensers (e.g., printheads) 314 and 322 to dispense respective agents (including agent 316) on a build surface 318.

The build material spreader 310 can include a wiper or a re-coater roller, for example, to spread a dispensed build material layer 312 over the build surface 318. The build surface 318 can be a build platform 330 or a previously formed layer of build material, for example. After the build material spreader 310 forms the build material layer 312, the agent dispensers 314 and/or 322 selectively dispense respective agent(s) (e.g., 316) onto the newly formed build material layer 312. It is assumed that the agent(s) 316 is (are) dispensed into the control region 106 (FIG. 1) of the build material layer 312 during the calibration operation.

The energy source 304 is activated to heat and fuse the portion of the build material layer 312 on which the agent(s) 316 has been applied to form a layer of a control part(s) 320.

In some examples, the dispensing assembly 302 and energy source 304 can be mounted to a carriage (not shown) that can be movable across the build surface 318 in one direction, or in multiple directions.

In accordance with some examples of the present disclosure, the controller 308 can derive, based on measured thermal characteristics of test patches, an adjustment value used in performing a temperature offset based agent control (330) that adjusts an amount of an energy absorbing agent (or multiple energy absorbing agents) dispensed by the agent dispenser(s) 314 and/or 322 during a build operation.

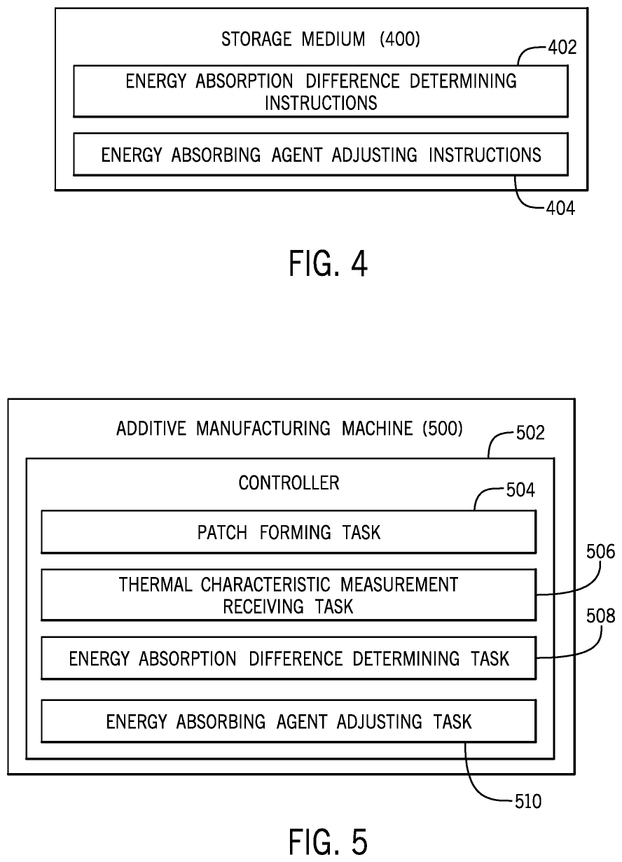

FIG. 4 is a block diagram of a non-transitory machine-readable or computer-readable storage medium 400 storing machine-readable instructions that upon execution cause a system to perform various tasks. The machine-readable instructions include energy absorption difference determining instructions 402 to determine a difference in energy absorptions by a plurality of different energy absorbing agents used to form an object by an additive manufacturing machine. As discussed above, the difference in energy absorptions by the plurality of different energy absorbing agents can be expressed by a thermal offset (e.g., temperature offset) between measured thermal characteristics (e.g., temperatures) of test patches formed using the different energy absorbing agents in corresponding build material layer(s).

The machine-readable instructions further include energy absorbing agent adjusting instructions 404 to adjust, based on the determined difference, an amount of an energy absorbing agent of the plurality of different energy absorbing agents dispensed for a build operation of the additive manufacturing machine.

FIG. 5 is a block diagram of an additive manufacturing machine 500 including a controller 502 to perform various tasks. The tasks include a patch forming task 504 to cause forming of patches using respective different energy absorbing agents. The tasks further include a thermal characteristic measurement receiving task 506 to receive measurements of thermal characteristics of the patches. The tasks additionally include an energy absorption difference determining task 508 to determine, based on the measurements, a difference in energy absorptions by the different energy absorbing agents used for forming a three-dimensional (3D) object by the additive manufacturing machine. The tasks also include an energy absorbing agent adjusting task 510 to adjust, based on the determined difference, an amount of a energy absorbing agent of the different energy absorbing agents dispensed for a build operation of the additive manufacturing machine.

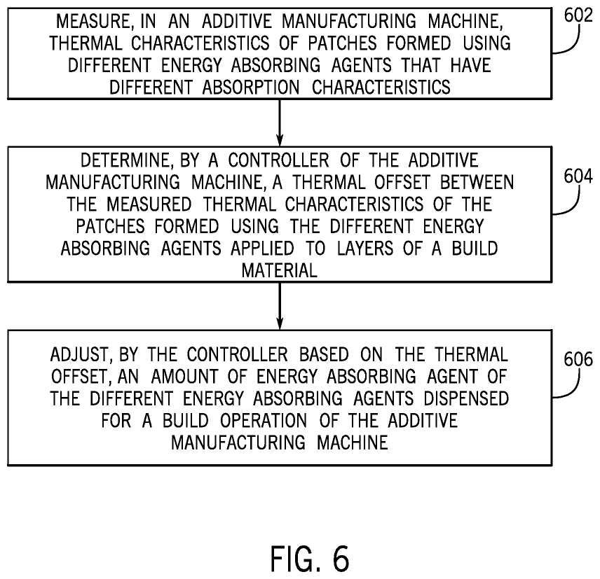

FIG. 6 is a flow diagram of a process according to some examples. The process includes measuring (at 602), in an additive manufacturing machine, thermal characteristics of patches formed using different energy absorbing agents that have different absorption characteristics. The process includes determining (at 604), by a controller of the additive manufacturing machine, a thermal offset between the measured thermal characteristics of the patches formed using the different energy absorbing agents applied to layers of a build material.

The process further includes adjusting (at 606), by the controller based on the thermal offset, an amount of a energy absorbing agent of the different energy absorbing agents dispensed for a build operation of the additive manufacturing machine.

The storage medium 400 of FIG. 4 can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site (e.g., a cloud) from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium storing instructions that upon execution cause a system to:
determine a difference in energy absorptions by a plurality of different energy absorbing agents used to form an object by an additive manufacturing machine; and
adjust, based on the determined difference, an amount of an energy absorbing agent of the plurality of different energy absorbing agents dispensed for a build operation of the additive manufacturing machine.

2. The non-transitory machine-readable storage medium of claim 1, wherein the adjusting of the amount of the energy absorbing agent dispensed for the build operation comprises:
determining, based on a digital representation of the object, an amount of the energy absorbing agent to be used for a layer of build material;
calculating an adjustment value based on the determined difference in energy absorptions by the plurality of different energy absorbing agents; and
changing the amount of the energy absorbing agent based on the adjustment value.

3. The non-transitory machine-readable storage medium of claim 1, wherein the adjusting is to balance energy absorptions by the plurality of different energy absorbing agents during the build operation that achieves a target energy absorption level in a layer of build material responsive to energy from an energy source, despite a variation in an energy absorption characteristic of at least one of the plurality of different energy absorbing agents.

4. The non-transitory machine-readable storage medium of claim 1, wherein the adjusting of the amount of the energy absorbing agent dispensed for the build operation comprises adjusting amounts of multiple energy absorbing agents of the plurality of different energy absorbing agents dispensed for the build operation.

5. The non-transitory machine-readable storage medium of claim 1, wherein the plurality of different energy absorbing agents comprise a first energy absorbing agent that is more energy absorptive in a particular energy bandwidth than a second energy absorbing agent.

6. The non-transitory machine-readable storage medium of claim 5, wherein the first energy absorbing agent comprises a first type of energy absorbing component, and the second energy absorbing agent comprises a second type of energy absorbing component.

7. The non-transitory machine-readable storage medium of claim 1, wherein the adjusting of the amount of the energy absorbing agent dispensed for the build operation comprises accessing lookup information that correlates different differences in energy absorptions by the plurality of different energy absorbing agents to corresponding different adjustment values that control the amount of the energy absorbing agent dispensed by an agent dispenser for the build operation.

8. The non-transitory machine-readable storage medium of claim 1, wherein the adjusting of the amount of the energy absorbing agent dispensed for the build operation comprises:
computing an adjustment value based on the determined difference in energy absorptions by the plurality of different energy absorbing agents; and
using the adjustment value to control the amount of the energy absorbing agent dispensed by an agent dispenser for the build operation.

9. The non-transitory machine-readable storage medium of claim 1, wherein the instructions upon execution cause the system to:
cause forming of a first test patch using a first energy absorbing agent of the plurality of different energy absorbing agents;
cause forming of a second test patch using a second energy absorbing agent of the plurality of different energy absorbing agents;
receive a first measurement of a thermal characteristic of the first test patch in response to energy applied by an energy source;
receive a second measurement of a thermal characteristic of the second test patch in response to energy applied by the energy source,
determine the difference in the energy absorptions based on the first and second measurements.

10. The non-transitory machine-readable storage medium of claim 9, wherein the first and second test patches are formed in different layers of build material or in a same layer of build material.

11. An additive manufacturing machine comprising:
a controller to:
cause forming of patches using respective different energy absorbing agents;
receive measurements of thermal characteristics of the patches;
determine, based on the measurements, a difference in energy absorptions by the different energy absorbing agents used for forming a three-dimensional (3D) object by the additive manufacturing machine; and
adjust, based on the determined difference, an amount of an energy absorbing agent of the different energy absorbing agents dispensed for a build operation of the additive manufacturing machine.

12. The additive manufacturing machine of claim 11, wherein the patches are formed in build material layers prior to formation of parts of the 3D object by the build operation.

13. The additive manufacturing machine of claim 11, wherein the patches are formed in a control region in one or more build material layers, the control region separate from a build region in which the 3D object is formed in the build operation.

14. A method comprising:
measuring, in an additive manufacturing machine, thermal characteristics of patches formed using different energy absorbing agents that have different absorption characteristics;
determining, by a controller of the additive manufacturing machine, a thermal offset between the measured thermal characteristics of the patches formed using the different energy absorbing agents applied to layers of a build material; and
adjusting, by the controller based on the thermal offset, an amount of a energy absorbing agent of the different energy absorbing agents dispensed for a build operation of the additive manufacturing machine.

15. The method of claim 14, wherein the different energy absorbing agents comprise a first fusing agent and a second fusing agent with different types of energy absorbing components.
